(19) United States
(12) Patent Application Publication
(10) Pub. No.: US 2023/0285114 A1
(43) Pub. Date: Sep. 14, 2023

(54) USER-FRIENDLY DENTAL CARE UNIT

(71) Applicants: Henri ANDELL, Espoo (FI); Tero PIHLAJAMÄKI, Helsinki (FI)

(72) Inventors: Henri ANDELL, Espoo (FI); Tero PIHLAJAMÄKI, Helsinki (FI)

(21) Appl. No.: 18/200,796

(22) Filed: May 23, 2023

Related U.S. Application Data
(63) Continuation of application No. 12/450,207, filed on Oct. 13, 2009, now abandoned.

(30) Foreign Application Priority Data
Mar. 19, 2007 (FI) 20075180

(51) Int. Cl. A61C 1/00; A61G 15/02; A61G 15/14

(52) U.S. Cl. CPC A61C 1/0015; A61G 15/02; A61G 15/14; A61C 1/0023

(57) ABSTRACT

A dental unit, which comprises connections for instruments and a control device and a microprocessor, which is arranged to control the dental unit. According to the invention, the microprocessor is arranged to control the dental unit according to a user specific user profile and the dental unit comprises a function for reading the user profile or a part of the user profile from an external record. The external record can be e.g. an USB memory stick or a record readable via a data network.

The present invention relates to a dental unit according to the preamble of claim 1.

A dental unit is a device to which one or more ancillary devices can be attached. Typical ancillary devices are the instruments used in dental treatment, as well as control devices. The dental unit is usually arranged to feed the ancillary devices with the electricity, water, compressed air, vacuum, or mechanical power that they require. Modern dental units are generally microprocessor controlled.

Typical instruments are, for example, micromotor and turbine drills, light curers, water sprays, and similar. Typical ancillary devices also include suction devices for removing saliva and treatment by-products from the mouth. The instruments and the suction devices are connected to the actual dental unit by means of hoses. The hoses of the instruments may contain water connections, air connections and electrical wires for operating the instruments, always according to the type of the instrument.

A typical control device for a dental unit is a foot control, which permits control commands to be given to the dental unit with the aid of a foot, at least during treatment operations. Foot controlling is more hygienic than hand-operated controls, as there is then no need to touch surfaces of the control in the middle of treatment. In addition, there is typically at least one hand control in a dental unit, such as a keypad or a touch surface. Dental units equipped with touch screens are also known. Other control alternatives may certainly also be used, e.g. voice control based on speech recognition.

Also a patient chair is usually attached to a dental unit, in which case the patient chair can also be controlled via the control devices of the dental unit. Other typical ancillary devices are an operation light and a flushing-water system, for example.

WO 2004/084753 presents a dental unit equipped with a graphical user interface.

WO 2006/037862 shows a dental unit, which can be connected to a computer over a data communications link..

WO 2005/070366 presents a computer-controlled dental unit comprising a graphical user interface and a data communications connection.

Modern dental units offer dentists several advanced functions. In modern dental units, there even has been predefined more advanced functions the performing of which is linked to several control functions, the performance of which includes several control commands for the ancillary devices of the dental unit and/or for the dental unit’s own systems. The defined functions may include, for example, functions programmed for specific treatment operations. Such a function can comprise, for example, guiding the patient chair to a proper position, control of switching the operation light on/off, and setting of the instruments into a proper operating status.

The advanced functions in a dental unit facilitate dentist’s work, as the dental unit with its ancillary devices can be set to a desired treatment status by a single control. On the other hand, adding of the more advanced functions requires a considerably more complex user interface and thus also makes it more difficult to use the dental unit. Yet, the dentist should be able to use any desired function during treatment as flexibly as possible and without any excess trouble or stress factors relating to control of the dental unit. Use of a more complex user interfaces becomes especially problematic for a dentist who works with several dental units within the same dental practise or in several different dental practices. In such case, it is likely that the user interfaces of the dental units differ from each other especially just regarding the more advanced functions. Differences between the user interfaces are due to variations in the models of the dental units being used. There may be significant differences also between different versions of the same model.

Another problem is the differences between the contents within the functions themselves. This means that in different dental units, a function programmed for a specific treatment operation can include different control commands or instrument setups. This causes problems corresponding to those of the differences in user interfaces.

The object of the invention is to facilitate use of dental units.

The invention is based on controlling a dental unit with the help of a microprocessor according to a user specific user profile. The dental unit is equipped with an operation of reading a user profile or a portion of a user profile from an external record.

More specifically, the method according to the invention is characterized by what is stated in the characterizing portion of claim 1.

With the aid of the invention, use of dental units may be facilitated. Namely, the invention makes possible for the dentist upon moving from one dental unit to another to easily always bring along his own settings to the dental unit to be used at a time, the settings being recorded in his user specific user profile.

In one embodiment, the user profile or a portion of it the dentist carries along with him contains user specific settings relating to a user interface of a dental unit.

In a second embodiment, the user profile or a portion of it the dentist carries along with him contains user specific settings relating to positioning of a patient chair.

In a third embodiment, the user profile or a portion of it the dentist carries along with him contains user specific settings relating to instrument settings.

In a fourth embodiment, the user profile or a portion of it the dentist carries along with him contains user specific settings relating to programmed functions.

In a fifth embodiment, the user profile or a portion of it the dentist carries along with him contains entire programmed functions.

In a sixth embodiment, the user profile or a portion of it the dentist carries along with him contains a combination of the user specific settings or functions of the first, the second, the third, the fourth, and the fifth embodiments mentioned above. Such a combination can contain two, several, or all of the information mentioned above.

With the help of the abovementioned embodiments, a dentist is able to start working more quickly when coming to a dental unit since there is no need to feed user specific settings in the dental unit manually via the user interface.

In one embodiment, the record external to the dental unit in which the user profile or a portion of it is recorded is designed to be carried along by the dentist. Such a record can be e.g. a disk, a smart card or a USB memory stick. In such an embodiment, the dental unit is equipped with a proper reading device for the record being carried along.

In another embodiment, the user profile is read from the record via a data communications link. In such case, the record may be e.g. in another dental unit or in a server connected to a network. In such an embodiment, the dental unit is equipped with a data communications link and the correct user profile or a portion of it is looked up from the record e.g. as a response to a successful login operation, in which the dentist is asked to feed in the dental unit the user ID and possibly also a password. The record described in the first embodiment designed to be carried along, such as a USB memory stick or a smart card, may also be used as an identifier of a dentist. The identification may also be done with the help of another physical identifier, such as a credit card, an RFID identifier or a fingerprint.

In one embodiment, the contents of the user profile itself, too, is editable and selectable by the user. What is meant by this is that in addition to setting values for the control operations or functions of the user profile, the user can select the control operations or functions to be selected to the user profile, too. Thus, the user profile enables recording in the user profile any of the adjustable settings of the dental unit without the need to include all possible settings of the dental unit in the user profile.

In the following, the invention is contemplated with the aid of examples and with reference to the accompanying drawings.

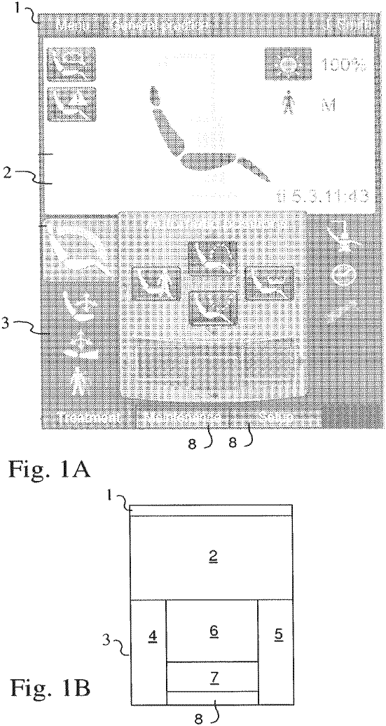

FIG. 1A shows an example of one possible view, which is shown on a display of a dental unit according one embodiment.

FIG. 1B shows schematically display fields of the display of FIG. 1A.

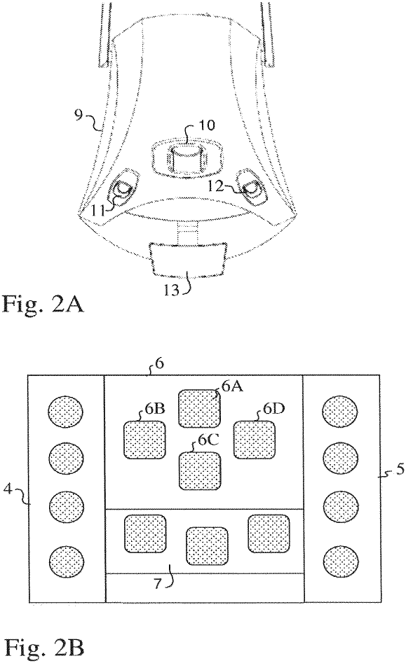

FIG. 2A shows a schematic top view of a foot control, which can be connected to a dental unit according to one embodiment.

FIG. 2B shows in greater detail a schematic view of a part of the view of FIG. 1B.

The dental unit of the example comprises connections for instruments, a control device, a patient chair, an operation light, a suction system, a flushing water system and a display. The dental unit also comprises a drive-power and feed-system for providing drive power or feed to the ancillary devices. The drive power or feed provided comprises at least one of the group: electricity, water, compressed air, vacuum, mechanical power, and light.

The dental unit comprises a control system for controlling the drive-power and feed-system and at least one ancillary device with the help of a microprocessor included in the control system. The control system comprises programmed functions, which contain at least one predefined control function being directed to at least one ancillary device. Additionally, at least one trigger is defined in the control system for each programmed function in response to which said programmed function is performed.

In the example, the microprocessor is arranged to control the dental unit according to a user specific user profile and the dental unit comprises a function of reading the user profile or a part of the user profile from a record external to the dental unit. Typically, the user profile is a file recorded in a record readable by an appropriate computer.

The dental unit can comprise a data communications link for reading the user profile or a part of the user profile from a server of a data network via a data communications link. Besides or instead of this, the dental unit may comprise a data communications link to another dental unit for reading the user profile or a part of the user profile via the data communications link from another dental unit. In addition to or instead of the abovementioned, the dental unit can comprise reading means for reading the user profile or a part of the user profile from a record carried along by the user, such as a memory stick.

The dental unit is preferably also equipped with a function in counter direction, with the help of which the user profile or a part of the user profile can be taken to a corresponding record external to the dental unit. By this way, the user profiles can be brought to the record directly from the dental unit. Another possibility would be to create the user profiles with the help of e.g. a computer.

In addition to a user specific user profile, the dental unit can be equipped with a dental unit specific device profile, in which case the microprocessor is arranged to control the dental unit according to both the device profile and the user specific user profile. In that case, also the function of taking the device profile to a record external to the dental unit and reading the device profile from said record external to the dental unit is realized so that it is easy to make a backup copy of the device profile and copy it to another dental unit, when desired.

The user profile itself can contain parameters for controlling instruments, for example. The user profile can also contain settings relating to control devices. A control device, for example a foot control which is typically used, comprises several press buttons or other selectors, and the user profile can contain settings defining responses to the use of the selectors. For example, the user profile may define a response to one or several selectors, in other words, for example, which function will be implemented as a response to pressing a particular press button of the foot control.

Typically, the dental unit comprises a display on which one can present a menu containing icons relating to functions of the dental unit. Feeds relating to these icons can be received from the control device, and then control instruments or other ancillary devices based on the feeds received. In connection with such a dental unit, the user profile preferably also contains user specific settings relating to the contents of the menu.

The user specific settings relating to the contents of the menu can contain settings relating to the appearance and/or location of the icons, for example. With the help of the settings relating to the appearance of the icons one may define, for example, the picture of the icon or the text linked to the icon. With the help of the settings relating to the location of the icons one may define, for example, in which place of the display the icon is presented. With the help of the settings relating to the location of the icons one can also define which icons are presented in any given menu, i.e. an icon can be defined to be located in a specific sub menu or main menu or it can be hidden from a menu altogether.

The user specific settings relating to the contents of a menu may contain, in addition to or instead of the above, settings of the functions linked with the icons or complete programmed functions, too. Here, a programmed function refers to a program which is arranged to control the dental unit to realize a combination of at least two control operations.

A control operation can be, for example, switching on an operation light, switching off an operation light, dimming an operation light, controlling a motor of a patient chair in order to steer the chair into a desired position, feeding of power to an instrument, feeding of water to an instrument, feeding of compressed air or vacuum to an instrument, filling a mug with water, flushing a spit bowl, switching a cooling mist for an instrument on or off, or sending for a dental assistant. By their nature, the control operations are simple basic control commands in the software of the dental unit, or very simple combinations of them.

By combining basic control commands it is possible to realize simple programmed functions, such as setting a power limit for an instrument, setting an operating status of an instrument, adjusting an operating status of an instrument, setting an operating status (view) of a display, adjusting cooling mist of an instrument, setting the operating time for suction, defining a control command for a control device, or defining control commands linked to selectors of a foot control.

However, the programmed functions may also contain complex and extensive combinations of basic control commands, or of other programmed commands. Generally, a programmed function contains a combination of two or more control operations and a definition for whether the control operations are to be performed e.g. consecutively or simultaneously. The control operations may be control operations mentioned above or other control operations the dental unit makes possible.

A programmed function can thus contain, for example, a control operation for steering a patient chair to a predefined position and one or more other controls combined with this. The other control can be, for example, control of an operation light and setting of the operating status of instruments.

One programmed function can be, for example, rinsing the patient’s mouth, which function includes filling of a mug with water, moving of the patient chair to a rinsing position. Termination of the function may be incorporated in the same function, which includes flushing of the spit bowl and moving of the chair to a getting-off or to an operation position. The termination may also be realized as a separate function.

A programmed function can contain control operations for controlling several, at least one instrument to predefined operating states.

In this example, the dental unit is arranged to realize a logging on operation when a dentist or another user comes to work at the dental unit. After the logging on operation, or in connection therewith, the dental unit is arranged to read a user profile from a record. After this, the microprocessor controls the dental unit such that the settings defined in the user profile are taken notice of. In case the user does not have a user profile, the dental unit reads default settings from a memory and controls its operation according to the default settings.

In the following, some conceivable functionalities in a dental unit according to one embodiment are presented at length.

### Logging on

Supposing there are several users of the dental unit, a logon view is shown on the display. The users may be, for example, dentists, dental assistants, or oral hygienists. The intent of the function is to make available user’s personal settings when the dental unit is set into the treatment mode.

Logging on takes place by selecting a proper user from the user menu in the logon view. The menu shows the users that are recorded on an internal memory device of the dental unit, on a USB flash drive connected to the dental unit, on an external database available to the dental unit, or some other suitable memory device

The dental unit is arranged to monitor its USB port and to display in a menu preferably the first users on the USB flash drive when a USB flash drive is placed in the USB port. The dental unit can also be programmed in such a way that, when a USB flash drive is placed in the USB port, only the users defined on the USB flash drive are shown in the menu. The other user data can be accessed through a separate selection key and by removing the USB flash drive from the USB port. It is possible to use a similar procedure with other memory devices carried by the user as well.

The users in the memory of the dental unit and in a possible database accessible through a data network are preferably displayed in alphabetical order, or through a menu with an alphabetical index if there are a considerable number of users.

The logon function also includes a possibility to logon to the dental unit as a guest. In that case, the dental unit is controlled on the basis of the default settings and the more advanced programmed functions will not be available.

The user can be required to enter a security code in connection with logging on.

After a successful logon, the microprocessor of the dental unit downloads the user profile from a memory device for its use, the user profile containing user specific settings. The user who has logged on can edit his own user-specific settings and record them back into the user profile on the memory device the user profile was retrieved from. The user profile can also be copied onto another memory device.

The user-specific user profile of this kind may contain settings, control-operation parameters and entire programmed functions programmed by the user.

### Display

FIG. 1A shows the basic view shown on the display in treatment mode. In different treatment and other use cases, the views will naturally differ from that shown in FIG. 1A and the basic view of the treatment mode, too, can be configured user-specifically. However, FIG. 1A is very suitable for illustrating advantageous properties of a graphical user interface of this embodiment. FIG. 1B shows schematically the same view divided in parts.

The views shown on the display comprise a header bar 1 at the upper edge of the display, through which it is possible to go to more extensive menus, such as for performing more advanced configuration and programming functions. This menu is most generally used through a keypad or some other manual control.

Below the header bar 1 there is an information panel 2 on which information is displayed regarded being important in the use case of the dental unit in question. For each treatment case, the dental unit includes an information view with default contents to be displayed on the information panel 2. In a preferred embodiment, the user may set the contents of each information view through a configuration function.

The lower half of the display shows a control panel 3, with the aid of which the user can use the functions of the dental unit, e.g. control the patient chair, edit settings, use a timer, and control instruments. Each function is linked to an icon shown on the control panel. The function is initiated or performed in response to a selection of the icon. The display being a touch screen, user’s control can be received through the display. Control directed to the functions indicated by the icons can also be received through a foot control, in a manner to be described later in greater detail. Thus, all of the functions shown on the control panel 3 are also available through the foot control.

The control panel 3 is divided into five parts. These parts are a left-hand menu 4, a right-hand menu 5, upper control icons 6, lower control icons 7, as well as maintenance and setup icons 8 on the lower edge of the display.

The view shown on the control panel 3, too, is operating-state-specific and can be configured by the user.

The parts of the control panel are linked to each other in such a way that, with the aid of the left-hand and right-hand menus 4 and 5, it is possible to select the function or function group to be used, in which case the control icons of the selected function or function group are shown on the upper and lower control icons 6 and 7. In the same way, also the view to be shown on the information panel 2 is selected, which view is thus also set to a desired state with the aid of the left-hand and right-hand menus 4 and 5. The icons shown on the menus 4 and 5 are shown in either an idle status or an active status in such a way that only one of the icons can be in an active status at any one time. The idle status and the active status can be differentiated e.g. with the aid of the colour of the icon. The left-hand and the right-hand menus 4 and 5 are preferably linked together in such a way that at a time, only on one of the menus 4 or 5 an icon can be in an active status.

In addition to the view shown in example, there are several other views on the display whose appearance and purpose can significantly differ from the view of the example.

### Foot Control

FIG. 2A shows a foot control 9. The foot control 9 comprises a centre selector 10, a left selector 11, a right selector 12, and a pedal 13. The centre selector 10 can be guided with a foot forwards, backwards, to the left, and to the right. The left and the right selectors 11 and 12 can be guided with a foot forwards and backwards. The pedal 13 can be pressed downwards and guided to the left and to the right.

A control command can be linked to each of the control movements described above. In the present embodiment, this is done through a graphical user interface shown on the display shown by FIGS. 1A and 1B. Then, it is possible to receive control commands through the foot control relating to use-case requirements and, if desired, also to user-specific menu views and the icons shown therein. Trough the foot control, it is thus possible to use the advanced functions of the dental unit.

In a preferred embodiment, the selectors of the foot control 9 are linked to the graphical user interface in a manner that will be described in the following, with reference to FIG. 2B. FIG. 2B is a partial view of FIG. 1B, in such a way that FIG. 2B shows only the control panel 3 of the display and, particularly, its left-hand menu 4, right-hand menu 5, upper control icons 6 and lower control icons 7. In this example, the icons of the menus 4 and 5 are shown by circular symbols and the control icons 6 and 7 by rounded squares.

In a preferred embodiment, the left-hand menu 4 of the display can be controlled using the left selector 11. The control is preferably implemented in such a way that pushing the left selector 11 forwards or backwards causes transition of one icon (and thus its related function) in the left-hand menu 4 to an active status. Steering the selector 11 forwards causes an upwards movement in the menu in such a way that when one icon is in the active status, based on this steering the active status is transferred to the next icon above. Correspondingly, steering the left selector 11 backwards causes transfer of the active status downwards in the left-hand menu 4. Should the highest or lowest icon be reached by the control, the active status will correspondingly transfer to the lowest or highest icon.

In a preferred embodiment, with the aid of the right selector 12, the right-hand menu 5 of the display is controlled in a manner corresponding entirely to that depicted above in connection with the left selector 11 and menu 4.

In a preferred embodiment, the upper control icons 6 are controlled with the aid of the centre selector 10. This is preferably implemented in such a way that pushing the centre selector 10 forwards means selecting the uppermost control icon 6A, pushing the centre selector 10 means selecting the left-hand control icon 6B, pushing the centre selector 10 backwards means selecting the lowest control icon 6C, and pushing the centre selector 10 to the right means selecting the right-hand control icon 6D. In response to the selection of an icon, the dental unit performs the control operation or programmed function linked to the icon.

In a preferred embodiment, the lower control icons 7 are controlled with the aid of the pedal 13 in a manner corresponding to that described in connection with the centre selector 10 and the icons 6. Pressing on the pedal and guiding it to the left and right thus represents, correspondingly, selection of the centre, the left-hand, and the right-hand icons. The control operation or programmed function linked to the icon is performed in response to the selection of the icon.

The division of the views of the display into parts depicted by the preferred embodiment, and control of these parts by the foot control, creates a user interface that is illustrative and easy to learn. Let it be once again stated, though, that also the setting relating to this user interface, its views and control commands may be arranged as editable by the user and record in a user profile.

Based on the examples presented above, it is clear that several solutions differing from the embodiments presented above can be realised within the framework of the invention. It is thus not the meaning to limit the invention to concern only the examples presented above but the scope of the patent is to be studied in the full extent of the attached patent claims.

1-20. (canceled)

21. Dental unit comprising connections for instruments and for a control device and a microprocessor, which is arranged to control the dental unit, characterized in that the microprocessor is arranged to control the dental unit according to a user specific user profile and the dental unit comprises a function for reading the user profile or a part of the user profile from a record external to the dental unit.

22. Dental unit according to claim 21 wherein the dental unit comprises a display and the microprocessor is arranged to show on the display a menu which contains icons related to functions of the dental unit and for receiving feeds from the control device relating to the icons and for controlling instruments on the basis of the feeds received.

23. Dental unit according to claim 22 wherein a lower half of the display shows a control panel with the aid of which the user can use the functions of the dental unit and wherein each function is linked to an icon.

24. Dental unit according to claim 23 wherein the icons can be accessed through a foot control and via a touch screen.

25. Dental unit according to claim 24 wherein the control panel comprises five parts including a left-hand menu, a right-hand menu, upper control icons, lower control icons, and maintenance/setup icons on a lower edge of the display.

26. Dental unit according to claim 25 wherein with the aid of the left-hand and right-hand menus it is possible to select the function to be used, in which case the control icons of the selected function are shown at the upper and lower control icons.

27. Dental unit of claim 25 wherein the icons shown on the left-hand and right-hand menus are shown in either an idle status or an active status in such a way that only one of the icons can be in an active status at any one time.

28. Dental unit of claim 27 wherein the idle status and the active status can be differentiated with the aid of the colour of the icon.
